(19) United States
(12) Patent Application Publication
(10) Pub. No.: US 2023/0197297 A1
(43) Pub. Date: Jun. 22, 2023

(54) SPACER GRID OF NUCLEAR FUEL ASSEMBLY

(71) Applicant: KEPCO NUCLEAR FUEL CO., LTD., Daejeon (KR)

(72) Inventors: Joo Young Ryu, Daejeon (KR); Chae Young Nam, Daejeon (KR); Han Gil Woo, Daejeon (KR); Nam Gyu Park, Daejeon (KR)

(21) Appl. No.: 16/981,182

(22) PCT Filed: Nov. 4, 2019
(86) PCT No.: PCT/KR2019/014809

§ 371 Date: Sep. 15, 2020

(30) Foreign Application Priority Data
Aug. 13, 2019 (KR) 10-2019-0098750

(51) Int. Cl. G21C 3/356; G21C 3/344; G21C 3/34

(52) U.S. Cl. CPC G21C 3/356; G21C 3/344; G21C 3/3432; G21C 3/3424

(57) ABSTRACT

Proposed is a spacer grid of a nuclear fuel assembly that may be manufactured using 3D printing with a high degree of design freedom, excluding sheet metal processing and welding processing. The spacer grid of the nuclear fuel assembly has hollow grid cells (110) having inner walls (111) arranged in a square lattice structure and connected to each other by being circumscribed, each of the grid cells including: a plurality of elastic support portions (112) protrudingly provided by being curved inwardly from the inner walls (111) and elastically supporting a fuel rod (10) in a state in which at least three elastic support portions are disposed at equal angles; and a plurality of inner mixing vanes (113) protrudingly provided while each upper tip portion thereof spirally turns along an associated one of the inner walls above the elastic support portions (112).

### TECHNICAL FIELD

The present invention relates to a spacer grid of a nuclear fuel assembly that may be manufactured using 3D printing with a high degree of design freedom, excluding sheet metal processing and welding processing.

### BACKGROUND ART

Nuclear fuel used in a nuclear reactor is manufactured by loading a plurality of the pellets into a cladding tube after molding enriched uranium into cylindrical pellets of a predetermined size. Such a plurality of the fuel rods constitutes a nuclear fuel assembly, is loaded into a core of the nuclear reactor, and is then burned through a nuclear reaction.

In general, the nuclear fuel assembly is configured to include: a plurality of fuel rods arranged in an axial direction; a plurality of spacer grids provided in a lateral direction of the fuel rods, thereby supporting the fuel rods; a plurality of guide tubes fixed to the spacer grids, thereby constituting a skeleton of the fuel assembly; and a top nozzle and a bottom nozzle supporting a top end and a bottom end, respectively, of each of the guide tubes.

The spacer grid is one of important components of the fuel assembly that restrains lateral movement of the fuel rods and suppresses axial movement with frictional force, thereby maintaining the arrangement of the fuel rods. Such spacer grids differ in shape and number depending on reactor types and designs but have a same structure providing grid cells which the fuel rods are inserted into and positioned in, wherein the spacer grids are classified into protective spacer grids, a lower spacer grid, an upper spacer grid, and intermediate spacer grids depending on the assembly location with the fuel rod and consist of a plurality of grid plates assembled to cross vertically.

In particular, a plurality of the intermediate spacer grids disposed between the lower spacer grid and the upper spacer grid constitutes most of the spacer grids. Here, the intermediate spacer grids play roles of maintaining the mechanical properties of the nuclear fuel and supporting the fuel rods by forming the skeleton of the nuclear fuel assembly and, at the same time, perform the function of mixing primary coolant so that heat generated from the uranium pellet may be easily transferred to the primary coolant through the fuel rod (cladding tube).

Specifically, the spacer grid is provided with grid springs elastically supporting the fuel rod and dimples limiting horizontal behavior of the fuel rod, in the grid cell. Such grid springs and dimples are provided by sheet metal processing of the spacer grid plates constituting each grid cell. In general, among the four surfaces of the grid cell, grid springs are provided on two surfaces, respectively, facing each other and a plurality of dimples are provided on the remaining two surfaces.

In a manufacturing process of the spacer grid, after assembling and fixing each of inner and outer grid plates which are sheet metal processed to a welding jig provided separately, laser welding is performed by melting and connecting the base material by irradiating, with a laser beam, the cross-welding portions of the inner grid plates, the junction portions of the inner/outer grid plates, and sleeve junction portions. Then, the spacer grid is manufactured through a series of processes for grinding work of weld beads generated in the welding process of the external grid plates.

On the other hand, the spacer grid is provided with a mixing vane protrudingly provided in a downstream direction of the coolant flow, and the mixing vane has a shape surrounding the periphery of the fuel rod and serves to promote heat transfer through mixing of the coolant around the fuel rod. In general, the mixing vane extends to a top end of the grid plate and has a predetermined shape to change the coolant direction and mix the coolant, and coolant mixing performance is determined according to size, shape, bending angle, and position thereof.

As described above, in the manufacturing process of the conventional spacer grid, there are a series of processes, such as a sheet metal process, a welding process, and the like. In addition, in a design process, the shape design technology of the mixing vane and the like to secure the dynamic impact strength for seismic performance and to mix coolant is considerably delicate.

The manufacturing process of the spacer grid of the related art is a stabilized technology, but a number of limitations occur in the shape design of the spacer grid because it goes through several stages of the manufacturing process as described above. In particular, the spacer grid of the related art provides the grid spring and dimple by processing the spacer grid plate sheet metal, so the number of the grid springs and dimples that may be designed in each grid cell is limited, thereby limiting the degree of design freedom.

In this connection, it has been reported that the impact strength of the spacer grid is significantly deteriorated at the end of life (EOL) condition. Therefore, in the development of future nuclear fuel, and also the development of nuclear fuel with an effective fuel region length of 14 ft taking high burnup and a long cycle into consideration, technology for securing seismic performance, and mechanical integrity under the EOL condition is inevitably required. However, the conventional method of manufacturing the spacer grid has limitations in implementing the spacer grid having sufficient stability and high strength under the EOL condition because of many limitations on the shape design.

### DOCUMENTS OF RELATED ART

### Patent Documents

Patent Document 1: Korean Patent Application Publication No. 10-2003-0038493 (Publication Date: May 16, 2003)
Patent Document 2: Korean Patent No. 10-0771830 (Registration Date: Oct. 30, 2007)

### DISCLOSURE

### Technical Problem

Accordingly, the present invention has been made keeping in mind the above problems occurring in the prior art, and an objective of the present invention is to solve the problems experienced in the related art and to provide a spacer grid of a nuclear fuel assembly that can be manufactured using 3D printing, which can exclude the use of a sheet metal and welding processes, increase the degree of design freedom, and simplify the manufacturing process thereof.

### Technical Solution

In order to accomplish the above objective, there may be provided a spacer grid of a nuclear fuel assembly according to the present invention, the spacer grid supporting fuel rods of the nuclear fuel assembly and having hollow grid cells having inner walls arranged in a square lattice structure and connected to each other by being circumscribed, each of the grid cells including: a plurality of elastic support portions protrudingly provided by being curved inwardly from the inner walls, and elastically supporting a fuel rod in a state in which at least three elastic support portions are disposed at equal angles; and a plurality of inner mixing vanes protrudingly provided while each upper tip portion thereof spirally turns along an associated one of the inner walls above the elastic support portions.

Each of the grid cells may have a cylinder shape, height of each of the inner mixing vanes may be continuously increased with respect to an axial direction in the associated one of the inner walls from a lowermost end thereof, but the height at an uppermost end of the inner mixing vane may be smaller than maximum height of each of the elastic support portions, and each of the inner mixing vanes may have the lowermost and uppermost ends coinciding with centers, respectively, of the longitudinal directions of the adjacent elastic support portions and may be provided by being rotated 1/k (k is the number of elastic support portions provided in each one of the grid cells) turns along the associated one of the inner walls.

Each of the grid cells may have a square column shape, and the inner mixing vanes may have the same radius from the central axis of each of the grid cells and are provided at corners, respectively, of each of the grid cells.

### Advantageous Effects

As described above, the spacer grid of the nuclear fuel assembly according to the present invention includes the plurality of elastic support portions protrudingly provided by being curved inwardly from the inner wall and elastically supporting a fuel rod in a state in which at least three elastic support portions are disposed at equal angles; and a plurality of inner mixing vanes protrudingly provided while each upper tip portion thereof spirally turning along the inner wall above the elastic support portions. As a result, there is an advantage wherein the spacer grid can have a simplified structure while securing a mechanical strength and enhancing mixing effect of coolant using 3D printing with a high degree of design freedom, excluding sheet metal processing and welding processing.

### DESCRIPTION OF DRAWINGS

FIG. 1 is a perspective configuration diagram of a spacer grid for a nuclear fuel assembly according to a first embodiment of the present invention.

FIG. 2 is a perspective configuration diagram of the spacer grid for the nuclear fuel assembly cut along line A-A of FIG. 1.

FIG. 3 is a plan view of the spacer grid for the nuclear fuel assembly according to the first embodiment of the present invention.

FIG. 4 is a perspective configuration diagram of a spacer grid for a nuclear fuel assembly according to a second embodiment of the present invention.

FIG. 5 is a perspective configuration diagram of the spacer grid for the nuclear fuel assembly partially cut along line B-B in FIG. 4.

FIG. 6 is a plan view of the spacer grid for the nuclear fuel assembly according to the second embodiment of the present invention.

FIG. 7 is a partially cut perspective view of the spacer grid for the nuclear fuel assembly showing another modification to the second embodiment of the present invention.

FIG. 8a to 10 are data showing flow analysis results for the present invention and comparative examples.

### BEST MODE

Specific structural or functional descriptions presented in embodiments of the present invention are exemplified for the purpose of explaining the embodiments according to the concept of the present invention, and the embodiments according to the concept of the present invention may be implemented in various forms. In addition, it should not be construed as being limited to the embodiments described herein but should be understood to include all modifications, equivalents, and substitutes included in the spirit and scope of the present invention.

Meanwhile, terms used in the present specification are only used to describe specific embodiments, and are not intended to limit the present invention. Singular expressions include plural expressions unless the context clearly indicates otherwise. In the present specification, the terms “include” or “have” are intended to designate the presence of a feature, a number, a step, an action, a component, a part, or combination thereof, which are implemented, and it should be understood that possibilities of the presence or addition of one or more other features or numbers, steps, actions, components, parts, or combinations thereof are not excluded in advance.

The present invention is to provide a spacer grid capable of being manufactured by metal 3D printing, excluding the sheet metal processing and welding process among manufacturing processes of the spacer grid and may eliminate limitations on the shape design of the spacer grid manufactured by the conventional sheet metal processing and welding process and shorten the manufacturing process.

In general, various metal 3D printing devices are available. For example, a 3D printing device from Germany’s Concept Laser has a maximum manufacturable size of 250×250×280 [symbol] so that the full-size spacer grid may be manufactured, and uses a powder bed fusion (PBF) method in which the product is manufactured by laying a layer of powder of several tens of µm on a powder bed having a predetermined area in a powder supply device, selectively irradiating the powder bed with a laser or electron beam according to a design drawing, and then melting and stacking the layer one by one. On the other hand, the spacer grid of the present invention may employ a general metal lamination manufacturing method in general metal 3D printing and is not limited to a specific method.

Hereinafter, embodiments of the present invention will be described in detail with reference to the accompanying drawings.

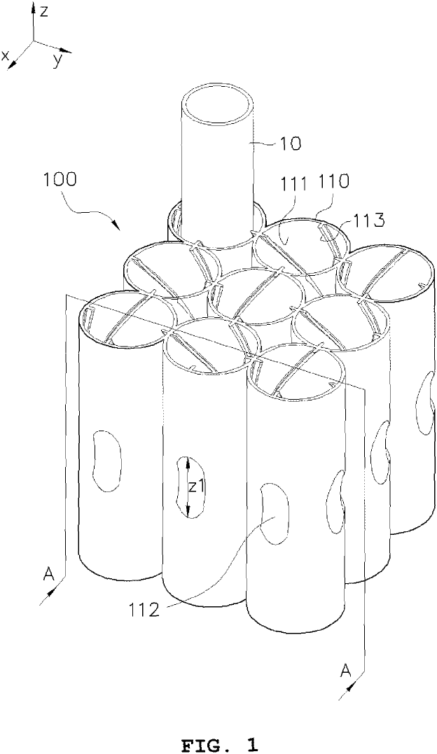

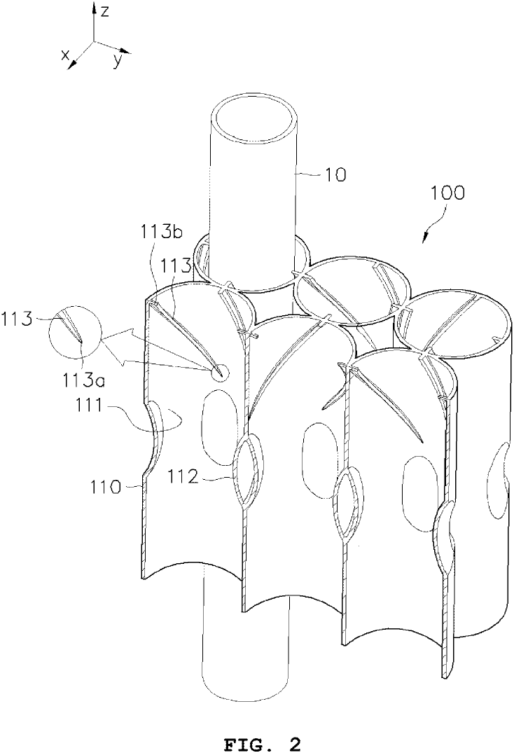

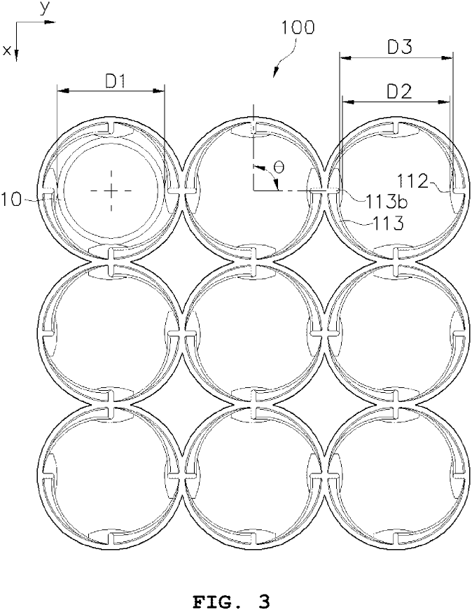

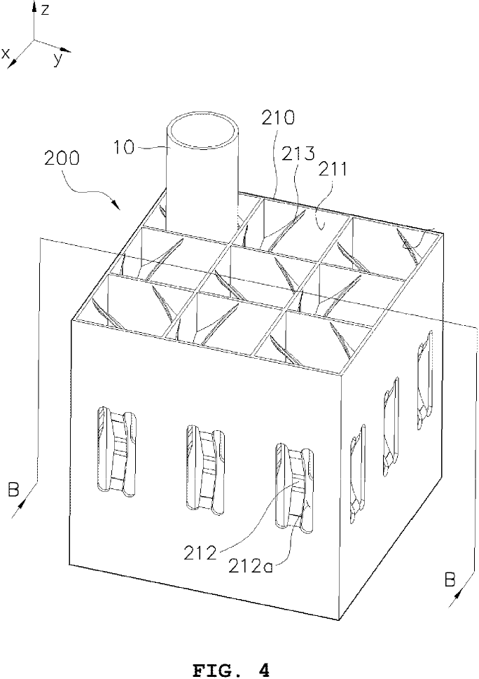

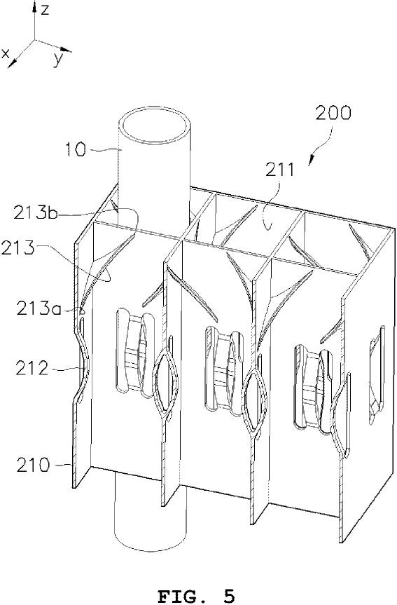

FIG. 1 is a perspective configuration diagram of a spacer grid for a nuclear fuel assembly according to a first embodiment of the present invention, FIG. 2 is a perspective configuration diagram of the spacer grid for the nuclear fuel assembly cut along the line A-A of FIG. 1, and FIG. 3 is a plan view of the spacer grid for the nuclear fuel assembly according to the first embodiment of the present invention. In the following description, an axial direction means a rotation axis of a grid cell having a cylinder shape, and corresponds to a z-axis direction in the drawing.

With reference to FIGS. 1 to 3, in the spacer grid 100 of the first embodiment, the hollow cylindrical grid cells 110 having an inner wall 111 are arranged in a square lattice n×n structure and connected to each other by being circumscribed, and the inner wall 111 of each grid cell 110 is integrally provided with a plurality of elastic support portions 112 and spiral inner mixing vanes 113.

The grid cell 110 has an inner diameter larger than the diameter of a fuel rod 10, and the fuel rod 10 is inserted and positioned therein. At this time, the fuel rod 10 is elastically supported by the plurality of elastic support portions 112. Here, each of the elastic support portions 112 may be an elliptical shape having a long axis z1 in the axial direction (z-axis) of the grid cell 110.

The inner mixing vane 113 is disposed on the inner wall 111 above the elastic support portion 112 corresponding to a downstream side of the coolant, and the upper tip portion is protrudingly provided from the inner wall 111 by spirally rotating along the axial direction (z-axis direction). Here, height of the inner mixing vane 113 is continuously increased from a lowermost end thereof with respect to an axial direction (z-axis) without a step, in the inner wall, and the height at an uppermost end 113b of the inner mixing vane may not exceed the maximum height of the elastic support portion 112. Further, the uppermost end 113b of the inner mixing vane 113 may coincide with an upper opening end of the grid cell 110.

Specifically, with reference to FIG. 3, the grid cells 110 of the present embodiment include four elastic support portions 112 each disposed in a direction perpendicular to each other with respect to the axial direction and four inner mixing vanes 113 disposed within a range of a constant arc angle θ. In particular, each inner mixing vane 113 is provided within a range of 90 degree angle which is the arc angle θ between two adjacent elastic support portions 112, and the lowermost and uppermost ends of each of the inner mixing vanes 113 each coincide with a center of the longitudinal direction of each of the elastic support portions 112. That is, in the present embodiment, each inner mixing vane 113 rotates helically ¼ turn between two elastic support portions 112. In another embodiment, when k (k is a natural number of no less than 3) elastic members are provided in the grid cell, the inner mixing vane provided between the elastic support portions may be provided by rotating 1/k turns along the inner wall.

The maximum height of each elastic support portion 112 is located at the same radius from the central axis of the grid cell 110. At this time, when the radius above is defined by a diameter ‘D2’, the diameter D2 of the elastic support portion 112 is smaller than the outer diameter D1 of the fuel rod 10 (D2 < D1). Therefore, the fuel rod 10 is elastically supported by the elastic support portion 112. Meanwhile, in the grid cell, a dimple for limiting the horizontal behavior of the fuel rod may be added to the grid cell in addition to an elastic spring elastically supporting, in direct contact with, the fuel rod, and the dimple may have various shapes within the range of a diameter larger than the outer diameter D1 of the fuel rod 10.

The height of the uppermost end 113b of each of the inner mixing vanes 113 is located at the same radius from the central axis of the grid cell 110. At this time, when the radius above is defined by a diameter ‘D3’, the diameter D3 of the uppermost ends 113b of the inner mixing vane 113 is larger than the diameter D2 of the elastic support portions 112 (D2 <D3).

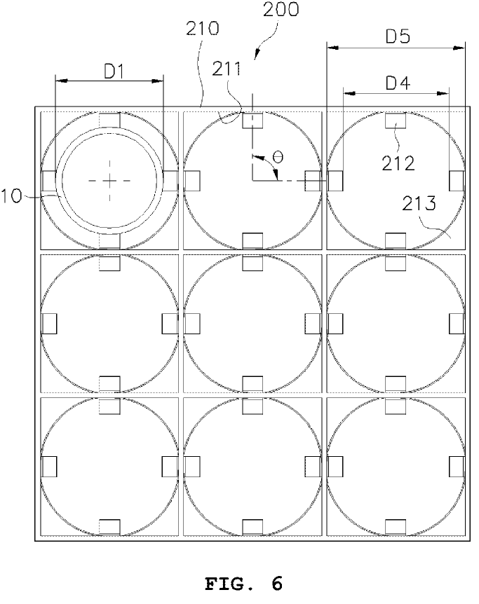

FIG. 4 is a perspective configuration diagram of a spacer grid for a nuclear fuel assembly according to a second embodiment of the present invention, FIG. 5 is a perspective configuration diagram of the spacer grid for the nuclear fuel assembly partially cut along line B-B in FIG. 4, and FIG. 6 is a plan view of the spacer grid for the nuclear fuel assembly according to the second embodiment of the present invention.

With reference to FIGS. 4 to 6, in the spacer grid 200 according to the second embodiment, square column-shaped grid cells 210 having inner walls 211 are arranged in a square lattice n×n structure and are connected to each other by being circumscribed. On the inner walls 211 of each grid cell 210, a plurality of elastic support portions 212 and spiral inner mixing vanes 213 is integrally provided.

The fuel rod 10 is inserted and positioned in the square column-shaped grid cell 210 and is elastically supported by the plurality of elastic support portions 212 protrudingly provided from each inner wall 211. Here, the elastic support portion 212 may be a strip shape curved in an axial direction (z-axis) of the grid cell 210, and holes 212a open on opposite sides may be provided. For reference, such a strip-shaped plate spring structure may be understood as a shape similar to a general grid spring employed in a related art spacer grid, but the related art spacer grid is not able to have the grid springs in opposite directions for the same grid plate, as the grid spring is processed by the sheet metal processing. On the other hand, in 3D printing, since grid springs may be provided on both opposite sides of the same grid plate, it is possible to increase the degree of freedom of the grid spring design of the spacer grid (see FIG. 5).

The inner mixing vane 213 is disposed on the inner wall 211 above the elastic support portion 212 corresponding to a downstream side of the coolant, and the upper tip portion is protrudingly provided from the inner wall 211 by spirally rotating along the axial direction (z-axis direction). The inner mixing vane 213 has a lowermost end 113a and an uppermost end 213b connected continuously without a step in the inner wall 211 and has a spiral shape along a certain radius with respect to a central axis of the grid cell 210. In addition, the uppermost end 213b of the inner mixing vane 213 may coincide with an upper opening end of the grid cell 210.

Specifically, with reference to FIG. 6, the grid cell 210 of the present embodiment includes the four elastic support portions 212 provided on each inner wall 211 in a direction perpendicular to each other with respect to the axial direction, and the four inner mixing vanes 213 provided within a range of a constant arc angle θ at each corner of the grid cells 210. In particular, each inner mixing vane 213 is provided at each corner of the square grid cell 210, and the lowermost and uppermost ends of each inner mixing vane 213 coincide with the central axis of each elastic support portion 212. That is, each inner mixing vane 213 rotates ¼ turn in a spiral shape between the two elastic support portions 212.

The maximum height of each elastic support portion 212, at the inner wall 211, is located at the same radius from the central axis of the grid cell 210.

At this time, when the radius above is defined by the diameter ‘D4’, the diameter D4 of the elastic support portions 212 is smaller than the outer diameter D1 of the fuel rod 10 (D4 < D1). Therefore, the fuel rod 10 is elastically supported by the elastic support portions 212. On the other hand, it is the same as in the previous embodiment that a dimple for limiting the horizontal behavior of the fuel rod may be added to the grid cell in addition to the elastic spring elastically supporting, in direct contact with, the fuel rod.

The inner mixing vane 213 has a spiral shape along the same radius from the central axis of the grid cell 110. At this time, when the radius is defined by a diameter ‘D5’, the diameter D5 of the inner mixing vanes 213 is larger than the diameter D4 of the support portions 212 (D4 < D5).

In the present embodiment, the diameter D5 of the inner mixing vanes 213 is illustrated to be the same as the inner length of one side of the grid cell 210.

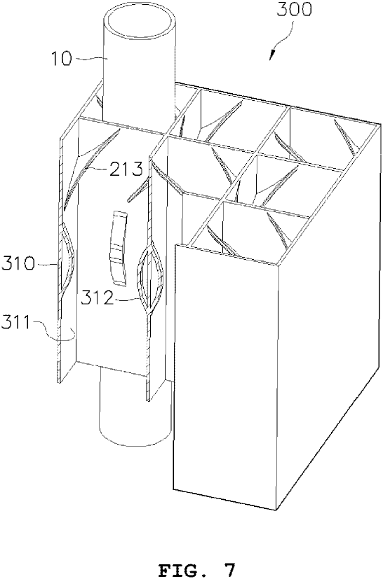

FIG. 7 is a partially cut perspective view of the spacer grid for the nuclear fuel assembly showing another modification to the second embodiment of the present invention.

With reference to FIG. 7, in a spacer grid 300 according to the present embodiment, square column-shaped grid cells 310 having inner walls 311 are arranged in a square lattice structure and are connected to each other by being circumscribed, and a plurality of elastic support portions 312 and spiral inner mixing vane 313 is integrally manufactured on the inner walls by 3D printing.

Particularly, in the present embodiment, the grid cell 310 is a solid plate in which slots or holes are not provided, and the elastic support portion 312 is provided to be curved and protruded in the grid cell 310. At this time, the elastic support portions 312 may be provided symmetrically on opposite sides of the same grid plate.

For reference, in the related art, the grid spring is provided by sheet metal processing of the grid plate and has a structure in which grid slots provided penetrating through the periphery of the grid spring are necessarily provided. On the other hand, in the present embodiment, considering the mechanical characteristics of the design of the spacer grid, the grid slot may be selectively processed as necessary, thereby increasing the design freedom of the spacer grid.

### Experimental Example

Computational fluid dynamics (CFD) analysis was performed for the first and second embodiments of the present invention, and for comparison, the same CFD analysis was performed for a conventional type spacer grid (HIPER17 type) having 3×3 grid cells provided with mixing blades on an upper portion, as a comparative example, and the results are shown in the following [Table 1].

TABLE 1

| | | Comparative example | Present invention | |
|---|---|---|---|---|
| | | | First embodiment | Second embodiment |
| Maximum temperature (K) | at outlet | 458 | 458 | 458 |
| | just above vane (or grid) | 483 | 480 | 475 |
| Average temperature (K) | at outlet | 454 | 454 | 453 |
| | just above vane (or grid) | 452 | 451 | 450 |
| Pressure (Pa) | at outlet | 0 | 0 | 0 |
| | just above vane (or grid) | 739 | 716 | 706 |
| | inlet | 1309 | 1273 | 1535 |

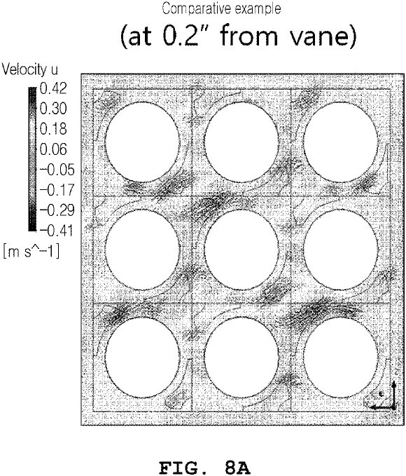

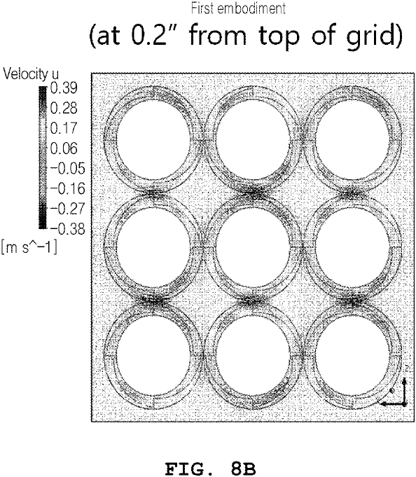

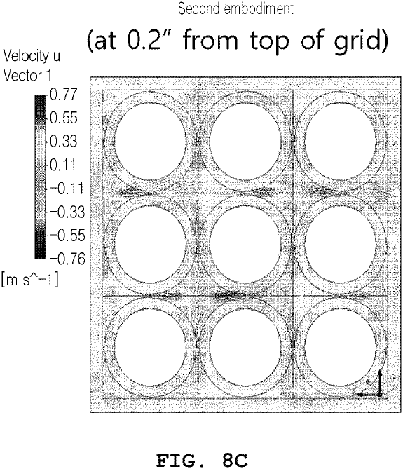

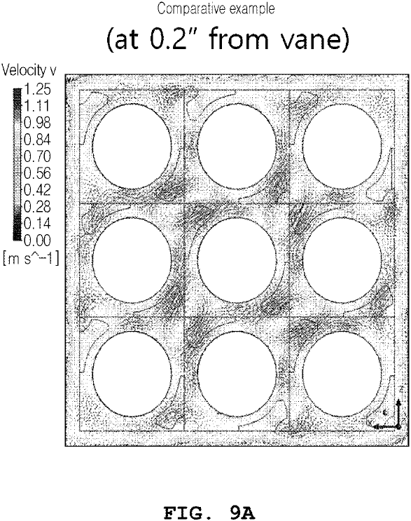

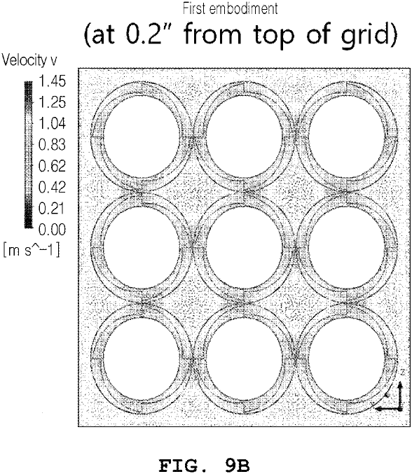

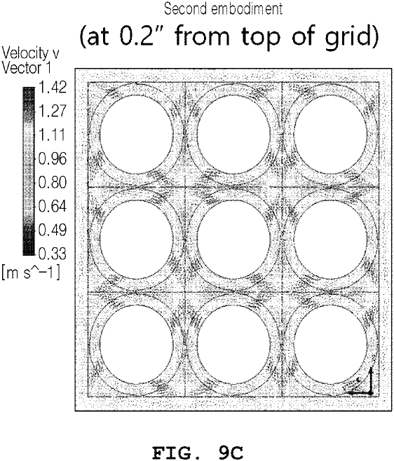

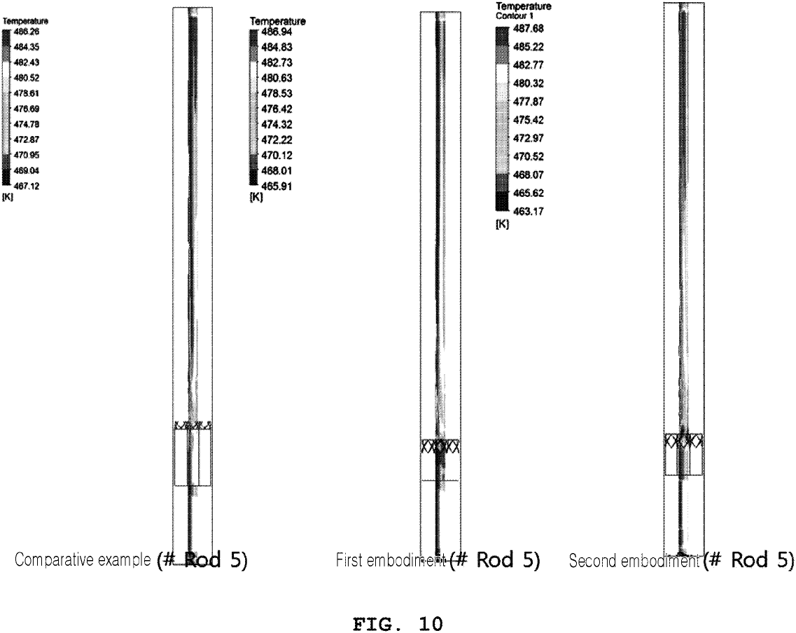

FIG. 8a to 10 are data showing the CFD analysis results for the present invention and a comparative example, and FIGS. 8a, 8b, 8c, 9a, 9b, and 9c show analysis results of the flow velocity in the x and y directions at a certain height from the mixing vanes and top of spacer grids of the comparative examples, respectively, and FIG. 10 shows the temperature analysis results for one fuel rod.

The present invention described above is not limited by the above-described embodiments and accompanying drawings. In addition, it will be obvious to those who have the knowledge in the related art to which the present invention pertains that various substitutions, modifications, and changes are possible within the scope of the present invention without departing from the technical spirit of the present invention.

### Description of the Reference Numerals in the Drawings

| | |
|---|---|
| 100, 200, 300 : | Spacer grid |
| 110, 210, 310 : | Grid cell |
| 111, 211, 311 : | Inner wall |
| 112, 212, 312 : | Elastic support portion |
| 113, 213, 313 : | Inner mixing vane |

1. A spacer grid of a nuclear fuel assembly, the spacer grid supporting fuel rods of the nuclear fuel assembly and having hollow grid cells having inner walls arranged in a square lattice structure and connected to each other by being circumscribed, each of the grid cells comprising:
a plurality of elastic support portions protrudingly provided by being curved inwardly from the inner walls, and elastically supporting a fuel rod in a state in which at least three elastic support portions are disposed at equal angles; and
a plurality of inner mixing vanes protrudingly provided while each upper tip portion thereof spirally turns along an associated one of the inner walls above the elastic support portions.

2. The spacer grid of claim 1, wherein each of the grid cells has a cylinder shape.

3. The spacer grid of claim 2, wherein height of each of the inner mixing vanes is continuously increased with respect to an axial direction in the associated one of the inner walls from a lowermost end thereof, but the height at an uppermost end of the inner mixing vane is smaller than maximum height of each of the elastic support portions.

4. The spacer grid of claim 3, wherein each of the inner mixing vanes has the lowermost and uppermost ends coinciding with centers, respectively, of the longitudinal directions of the adjacent elastic support portions and is provided by being rotated 1/k (k is the number of elastic support portions provided in each one of the grid cells) turns along the associated one of the inner walls.

5. The spacer grid of claim 1, wherein each of the grid cells has a square column shape.

6. The spacer grid of claim 5, wherein the inner mixing vanes have the same radius from the central axis of each of the grid cells and are provided at corners, respectively, of each of the grid cells.
